(19) United States
(12) Patent Application Publication
(10) Pub. No.: US 2017/0223984 A1
(43) Pub. Date: Aug. 10, 2017

(54) Method of Making a Dessert

(71) Applicant: Antonio Da Silva, Newark, NJ (US)

(72) Inventor: Antonio Da Silva, Newark, NJ (US)

(21) Appl. No.: 15/040,672

(22) Filed: Feb. 10, 2016

(51) Int. Cl. A23G 9/08; A23G 9/42; A23G 9/34; A23G 9/50; A23G 9/40

(52) U.S. Cl. CPC A23G 9/08; A23G 9/506; A23G 9/40; A23G 9/34; A23G 9/42; A23V 2002/00

(57) ABSTRACT

A method of making a dessert includes the steps of combining and mixing together sugar, flour, milk and vanilla bean seeds to define a first mixture. Sugared yellow yolks are added to the first mixture to define a second mixture. The second mixture is mixed at a temperature between 180° F. and 205° F. and then cooled and poured into a plurality cups each containing a pie crust. The cups and second mixture contained therein are frozen to define frozen desserts. The frozen desserts are later cooked to define finished desserts ready for consumption.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

(1) Field of the Invention

(2) Description of Related Art Including Information Disclosed Under 37 CFR 1.97 and 1.98.

The disclosure and prior art relates to desserts and more particularly pertains to a new dessert which is frozen and which may be served as an individual serving.

### BRIEF SUMMARY OF THE INVENTION

An embodiment of the disclosure meets the needs presented above by generally comprising the steps of combining and mixing together sugar, flour, milk and vanilla bean seeds to define a first mixture. Sugared yellow yolks are added to the first mixture to define a second mixture. The second mixture is mixed at a temperature between 180° F. and 205° F. and then cooled and poured into a plurality cups each containing a pie crust. The cups and second mixture contained therein are frozen to define frozen desserts. The frozen desserts are configured to be cooked to define finished desserts configured for consumption.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

Not Applicable

### DETAILED DESCRIPTION OF THE INVENTION

A new dessert embodying the principles and concepts of an embodiment of the disclosure will now be described.

The method of making a dessert 10 generally comprises combining a plurality of ingredients to define a first mixture which includes sugar, flour, mill and vanilla seeds. More particularly, the first mixture includes:

75 lbs to 85 lbs sugar;

10 lbs to 20 lbs flour;

8 gallons to 12 gallons milk; and

0.75 teaspoons to 1.25 teaspoons vanilla bean seeds.

These ingredients, of the first mixture are mixed for between 4 minutes and 12 minutes. The flour is preferably whole wheat flour while the milk will preferably contain 3% or 4% milk fat.

To the first mixture is added between 45 lbs and 55 lbs sugared yolks to define a second mixture. Sugared yolks are commonly available and typically include, by weight, approximately 90% egg yolk and 10% sugar. This second mixture is then mixed within a pasteurizing assembly which mixes the second mixture under heat. Generally, the second mixture is mixed for between 25 minutes and 40 minutes at a temperature between 180° F. and 205° F.

After the mixing of the second mixture has been completed, the second mixture is rapidly cooled using conventional methods and then poured into pre-formed pie crusts which are positioned within their own tins. The pie crusts preferably are made for individual portions and therefore will hold less than 2 cups of the second mixture and more particularly approximately 1 cup. Once the second mixture is poured into the pie crusts, they are frozen to define frozen desserts. At this point they may be individually packaged or packaged such that there are several frozen desserts in a single package. When a person would like to eat one of the frozen desserts, it is removed from the package and cooked for between 7 minutes and 12 minutes at between 450° F. and 500° F. to define a finished dessert configured to be consumed.

A specific embodiment of the above method includes the following:
1) A first mixture containing:
   80 lbs sugar;
   15 lbs flour;
   10 gallons milk containing 3% milk fat.
2) Mixing the first mixture for between 5 minutes and 10 minutes.
3) Adding 50 lbs of yellow sugared yolks to the first mixture to define a second mixture.
4) Mixing the second mixture for between 26 minutes and 35 minutes at 200° F.
5) Cool the second mixture.
6) Pour the second mixture into pie crust cups.
7) Freeze the second mixture and pie crust cups.
8) Bake the frozen second mixture and pie crust cup at 475° F. for 9 minutes.

In use, the method provides a plurality of desserts which may be quickly baked to provide individual servings.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A method of making a dessert comprising the steps of:
combining to define a first mixture:
sugar;
flour;
milk;
vanilla bean seeds;
mixing said first mixture;
adding to said first mixture sugared yolks to define a second mixture;
mixing said second mixture at a temperature between 180° F. and 205° F.;
cooling said second mixture and pouring said mixture into a plurality cups each containing a pie crust; and
freezing said cups and said second mixture contained therein to define frozen desserts, wherein said frozen desserts are configured to be cooked to define finished desserts configured for consumption.

2. The method of making a dessert according to claim 1, wherein:
said first mixture includes:
75 lbs to 85 lbs of said sugar;
10 lbs to 20 lbs of said flour;
8 gallons to 12 gallons of said milk;
0.75 teaspoons to 1.25 teaspoons vanilla bean seeds; and
said second includes between 45 lbs and 55 lbs of said sugared yolks.

3. A method of making a dessert comprising the steps of:
combining to define a first mixture:
75 lbs to 85 lbs sugar;
10 lbs to 20 lbs flour;
8 gallons to 12 gallons milk;
0.75 teaspoons to 1.25 teaspoons vanilla bean seeds;
mixing said first mixture for between 4 minutes and 12 minutes;
adding to said first mixture between 45 lbs and 55 lbs sugared yolks to define a second mixture;
mixing said second mixture for between 25 minutes and 40 minutes at a temperature between 180° F. and 205° F.;
cooling said second mixture and pouring said mixture into a plurality cups each containing a pie crust;
freezing said cups and said second mixture contained therein to define frozen desserts; and
cooking at least one of said frozen desserts for between 7 minutes and 12 minutes at 475° F. to define a finished dessert configured to be consumed.
